(19) United States
(12) Patent Application Publication
(10) Pub. No.: US 2005/0223777 A1
(43) Pub. Date: Oct. 13, 2005

(54) Specimen holding plate for a gas permeability measuring apparatus

(76) Inventors: Henning Jensen, Frederiksberg (DK); Kasper Klausen, Kobenhavn (DK); Elvin Schmidt Solberg, Vordingborg (DK); Kenneth Hansen, Fjenneslev (DK)

Correspondence Address: SUGHRUE MION, PLLC, 2100 PENNSYLVANIA AVENUE, N.W., SUITE 800, WASHINGTON, DC, 20037, US

(21) Appl. No.: 10/508,695

(22) PCT Filed: Apr. 10, 2003
(86) PCT No.: PCT/DK03/00240

§ 371 Date: May 19, 2005

(30) Foreign Application Priority Data
Apr. 16, 2002 (DK) PA 2002 00560

(51) Int. Cl. G01N 15/08

(52) U.S. Cl. 73/38; 73/864.91

(57) ABSTRACT

A specimen holding plate (1) for a gas permeability measuring apparatus. The specimen holding plate comprises a first surface (2) and a second surface (3), a number of passages (11, 12) between said second surface (3) and said first surface (2) so as to allow a predetermined gas mixture to be supplied to a first volume located at least partially about said first surface. The specimen holding plane further compresses a sealing arranged in a connection with said first surface and circumscribing said passages (11, 12) so as to circumferentially delimit said first volume. The sealing is provided as a double sealing (7, 8).

The present invention relates to a specimen holding plate for a gas permeability measuring apparatus, the specimen holding plate comprising a first surface and a second surface, a number of passages between said second surface and said first surface so as to allow a predetermined gas mixture to be supplied to a first volume located at least partially above said first surface, and a sealing arranged in connection with said first surface and circumscribing said passages, so as to circumferentially delimit said first volume. The present invention further relates to the use of such a specimen holding plate.

In gas permeability measuring apparatuses a specimen is held so as to form a boundary between two volumes, one on either side of the specimen. The two volumes are filled with different gas mixtures or different gas mixtures are circulated there through. In connection with at least one of the volumes at least one measuring sensor for a gas of interest is arranged. Sensors for different gasses of interest may be on the same or different sides of the membrane, depending on which way the respective gas permeates the membrane. An example of such a measuring device is known from EP-A-727655.

In prior art devices the specimen is typically held by clamping action between a specimen holding member, in the form of a metal plate with a circular sealing, on which the specimen is placed, and a clamping member pressing the specimen against the sealing member. The metal plate, the sealing member, and the specimen thus form a flat cylindrical volume. The clamping member may be a similar arrangement, i.e. a second holding plate so as to form two cylindrical volumes on either side of the specimen.

When different gas mixtures are circulated on either side of the specimen gas will, depending on the permeability of the specimen for that specific gas permeate from one side to the other, allowing the change in partial pressure thereof to be measured.

In the above as well as the following it should be noted that gas mixture is used in the broadest sense possible, i.e. also for a pure gas with essentially only one constituent.

It has however shown that the prior art specimen holding plates suffer from substantial drawbacks in sealing properties, which may under certain circumstances lead to incorrect or even useless measurings, because gasses are not only exchanged between the known gas mixtures in the volumes on either side of the membrane but also between the respective volume and the surroundings because the sealing is insufficiently gas tight. In particular the gas mixture of the surroundings may be different from both of the two gas mixtures on either side of the specimen. The amount of gas entering the flat cylindrical chamber in the radial direction from the surroundings via the sealing may be so substantial compared to the amount permeating the membrane in the axial direction that measuring is impossible.

Attempts have been made to improve sealing by means of grease, silicone or the like. This is however not desirable, as such materials have a tendency to block the porosities of the specimen, thereby influencing the permeability thereof which then results in incorrect measurings.

It is the object of the present invention to overcome the above sealing problems in a permeability measuring apparatus.

According to the present invention this object is achieved by a specimen holding plate according to the opening paragraph, wherein the sealing is provided as a double sealing.

Thereby a chamber is formed between the two sealing members. The chamber may then contain a gas mixture corresponding to the measuring gas or the reference gas, as the case may be, in the first volume. Gasses from the surroundings may only in the first instance penetrate to the chamber, whereby the penetration process to the first volume is substantially retarded.

In a preferred embodiment the double sealing comprises a first sealing member and a second sealing member arranged in connection with said first surface, where the second sealing member circumscribes the first sealing member, and where between said sealing members a second number of passages allowing a gas mixture corresponding to said predetermined gas mixture to be circulated are provided.

By circulating a gas mixture corresponding to the predetermined gas mixture, the chamber formed between the two sealing members will continuously be flushed so that any gas penetrating the second sealing member is removed before it can penetrate the first sealing member and corrupt the measuring.

In a further preferred embodiment the sealing members are located in grooves in said first surface.

This ensures good positioning of the sealing members. This is in particularly advantageous if two opposing holding plates with respective sealing members are used on either side of a thin specimen, where it is important that the positions of the respective sealings match, in order to get good sealing properties.

Preferably the first and the second sealing members are concentrically arranged o-rings.

O-rings are rather cheap in manufacturing, and the symmetry thereof allows easy positioning, which is in particular of advantage if two opposing holding plates are used as described above.

In a particularly preferred embodiment the specimen holding plate comprises a further groove arranged concentrically between said sealing members and in communication with said second number of passages.

This provides good communication between the inlet opening and the outlet opening, which ensures good flushing of the chamber between the two sealing members.

An important aspect of the present invention relates to the use of a specimen holding plate where said gas mixture is a reference gas mixture or a measuring gas mixture.

The use of the appropriate gas mixture corresponding to the gas mixture in the first volume substantially improves the measuring accuracy.

In particular, good measuring accuracy may be achieved when the specimen is clamped between the respective sealings of the two specimen holding plates, and when between the first and second sealing members of the first specimen holding plates a reference gas is circulated and between the first and second sealing members of the second specimen holding plate a measuring gas is circulated.

For better understanding the invention will now be described in greater detail, by means of a nonlimiting, example illustrated in the figures, in which

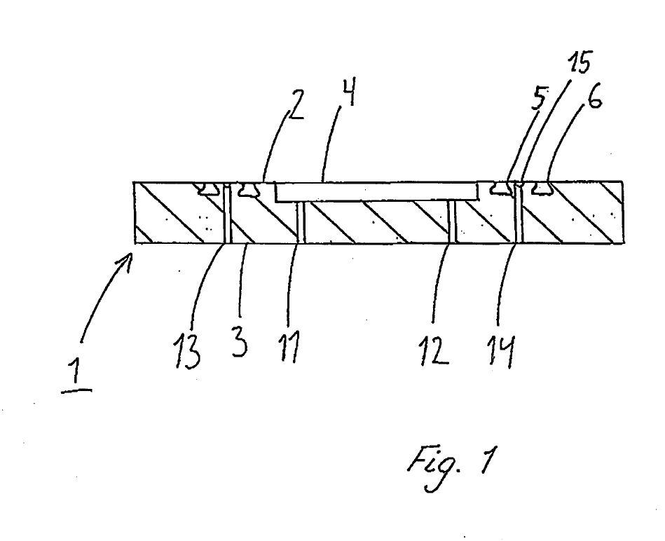

FIG. 1 shows a schematic cross sectional view of the specimen holding plate according to the invention, and

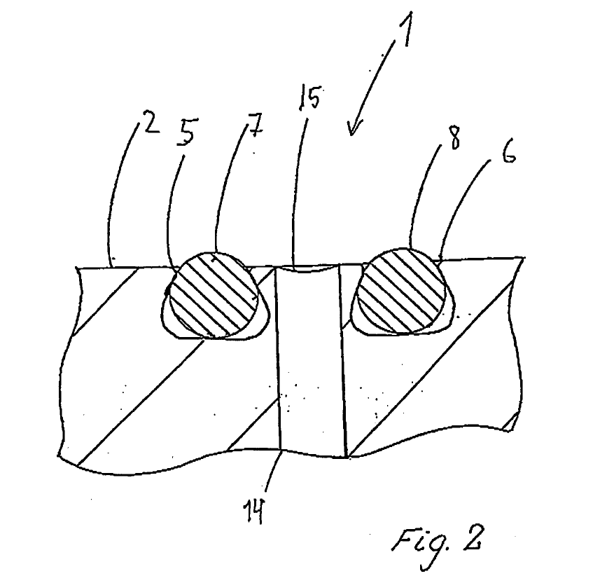

FIG. 2 shows a partial cross sectional view of the grooves for the double sealing with the sealings in place.

FIG. 1 shows a schematic cross sectional view of the specimen holding plate 1 according to the invention. The specimen holding plate 1 has an overall circular shape or rectangular shape with a first upper surface 2, and a second bottom surface 3. In the first surface an gas chamber 4 provided. Circumscribing the gas chamber 4 are two grooves 5 and 6. These grooves 5 and 6 are adapted to accommodate two O-rings 7 and 8, seen only in FIG. 2, which protrude slightly over the first surface 2. Since the O-rings serve as sealings they are of an appropriate resilient material, such as Nitrile rubber, silicone rubber, Viton® or natural rubber. Though O-rings are preferred the skilled person will appreciate that other types of sealings may be employed, e.g. V or lip seals. The specimen holding plate is of any suitable air or gas tight material, such as a metal or an alloy. In the preferred embodiment, the metal is an AlMgSi alloy.

In use a specimen is placed in the central area of the specimen holding plate 1, where it rests on the two concentric O-rings 7 and 8. The specimen holding plate 1 may then be inserted into the permeability measuring apparatus, where a clamping member is lowered onto the specimen, thereby forcing it against the O-rings 7 and S. This forms a first volume under the specimen, the volume being delimited by the specimen, the inner O-ring 7 and the walls of the gas chamber 4, and parts the first surface 2 of the specimen holding plate 1. In this volume a measuring gas mixture or a reference gas mixture is circulated. It should be noted that the gas chamber 4 is not necessary for the invention, but is only preferred in order to ensure good circulation. If desired, other means for ensuring the circulation, such as a groove pattern in the surface 2, could be used instead.

The clamping means preferably is constructed in a manner similar to the specimen holding plate 1, in the sense that it allows a volume to be formed above the specimen, in which volume a gas mixture differing from that of the first volume is present.

The gas chamber 4 helps to ensure good circulation of a measuring gas mixture or a reference gas mixture in the first volume. The gas chamber 4 with at least one inlet passage 11 and at least one outlet passage 12, allowing the gas mixture to be supplied to the first volume, where the exchange of gas may take place through the specimen, and an outlet passage through which the gas mixture may be withdrawn to a measuring device.

In order to prevent gas to penetrate to the first volume via the sealing, the sealing is constructed as a double sealing, comprising the first and second sealing members 7 and 9. When the specimen is in place and clamped against the sealing members 7 and 8, a second chamber is formed between the concentric sealing members 7 and 8. If this second chamber is filled with the same gas mixture as is supplied to the first volume, it substantially retards the undesired radial penetration of gas from the surroundings into the first volume via the sealing.

In order to enhance this effect an inlet passage 13 and an outlet passage 14 are provided. If a gas mixture corresponding to the one supplied to the first volume is also circulated through the chamber between the two sealing members 7 and 8, the chamber is efficiently flushed, thereby removing any undesired gas that may have penetrated the outer sealing member 8 before it ever gets a chance to penetrate beyond the first sealing member 7 where it would corrupt the measuring.

In order to ensure a good flushing of the chamber formed between the sealing members 7 and 8 a further concentric groove 15, which connects the inlet passage 13 and the outlet passage 14, is provided between the grooves 5 and 6.

In the above the terms reference gas mixture and measuring gas mixture have been used, In principle this is only to distinguish between the gas mixtures on the different sides of the specimen, because measurements may be made on either side thereof.

In a specific example of a measurement using the specimen holding plate 1 of the invention, a thin foil for a bag for foodstuff would be placed in the holding plate 1 and clamped so as to form the first volume. Through the first volume a gas mixture of 20% carbon dioxide and 80% nitrogen could be circulated. To the other side of the membrane a gas mixture corresponding to the air of the atmosphere could be supplied in order measure how much oxygen permeates the foil.

In this case, the chamber between the two sealing members 7 and 8 constituting the double sealing could advantageously be flushed with the gas mixture of 20% carbon dioxide and 80% nitrogen. This would prevent the oxygen from entering into the first volume by any other way than through the foil. Any oxygen in the surrounding atmosphere which penetrates the outer sealing member 8 would be efficiently flushed and not reach the first volume.

On the other hand the rise in partial pressure of oxygen in the first volume is not so substantial that the penetration thereof through the second sealing 7, and flushing from the chamber between the sealing members 7 and 8 would influence the measurement, substantially.

1. A specimen holding plate for a gas permeability measuring apparatus,
the specimen holding plate comprising a first surface and a second surface, a number of passages between said second surface and said first surface so as to allow a predetermined gas mixture to be supplied to a first volume located at least partially above said first surface, and a sealing arranged in connection with said first surface and circumscribing said passages, so as to circumferentially delimit said first volume,
said sealing being provided as a double sealing.

2. A specimen holding plate according to claim 1, wherein said double sealing comprises a first sealing member and a second sealing member arranged in connection with said first surface wherein the second sealing member circumscribes the first sealing members, and wherein a second number of passages are provided between said first and second sealing members said passages allowing a gas mixture corresponding to said predetermined gas mixture to be circulated.

3. A specimen holding plate according to claim 2, wherein the first and second sealing members are located in grooves in said first surface.

4. A specimen holding plate according to claim 2, wherein the first and the second sealing members are concentrically arranged O-rings.

5. A specimen holding plate according to any one of claim 3, comprising a further groove arranged concentrically between said first and second sealing members and in communication with said second number of passages.

6. The use of a specimen holding plate according to claim 1, wherein said gas mixture is a reference gas mixture.

7. The use of a specimen holding plate according to claim 1, wherein said gas mixture is a measuring gas mixture.

8. The use of two specimen holding plates according to claim 1, wherein the specimen is clamped between the respective sealings of the two specimen holding plates.

9. Use according to claim 8, wherein between the first and second sealing members of the first specimen holding plate a reference gas is circulated and wherein between the first and second sealing members of the second specimen holding plate a measuring gas is circulated.

10. A specimen holding plate according to claim 3, wherein the first and the second sealing members are concentrically arranged O-rings.
